(19) United States
(12) Patent Application Publication
(10) Pub. No.: US 2025/0391258 A1
(43) Pub. Date: Dec. 25, 2025

(54) LOCATING A WEARABLE DEVICE

(71) Applicant: Kadex B.V., Wijchen (NL)

(72) Inventor: Joost Megens, Lent (NL)

(21) Appl. No.: 18/752,346

(22) Filed: Jun. 24, 2024

(51) Int. Cl. G08B 21/04; G01S 7/48; G01S 13/04; G01S 17/06; H04W 4/021

(52) U.S. Cl. CPC G08B 21/0438; G01S 7/4808; G01S 13/04; G01S 17/06; H04W 4/021

(57) ABSTRACT

A method for locating a wearable device. The method is performed by a location determiner being separate from the wearable device. The method comprises: determining a selected localisation procedure to be a first localisation procedure or a second localisation procedure, wherein the selected localisation procedure is determined to be the first localisation procedure based on a fixed radio receiver detecting a beacon signal from the wearable device, and wherein the selected localisation procedure is determined to be the second localisation procedure based on the fixed radio receiver failing to detect a beacon signal from the wearable device; and determining a location indication of the wearable device based on the selected localisation procedure.

### TECHNICAL FIELD

The present disclosure relates to the field of locating wearable devices and in particular to conditionally locating a wearable device using a first localisation procedure or a second localisation procedure.

### BACKGROUND

Healthcare automation is a field with increased interest. One field in which healthcare automation can be used is for monitoring of people that could wander off without having the capability of finding their way back, e.g., for people suffering from dementia or similar conditions. Users of the system can be monitored and are also provided with opportunities of triggering an alarm. The healthcare automation thereby provides a more safe and secure environment for the users.

In the prior art, there are wearable devices that can be worn as a necklace or as a bracelet. Such wearable devices can be used, for instance, to trigger an alarm to get emergency assistance. Localisation of the wearable device can also be performed.

Such wearable devices would ideally be usable for a long time without charging or exchanging batteries. In other words, power efficiency is of great importance.

### SUMMARY

One object is to provide a wearable device, for a healthcare monitoring system, that supports localisation in multiple environments in a power efficient manner.

According to a first aspect, it is provided a method for locating a wearable device. The method is performed by a location determiner being separate from the wearable device. The method comprises: determining a selected localisation procedure to be a first localisation procedure or a second localisation procedure, wherein the selected localisation procedure is determined to be the first localisation procedure based on a fixed radio receiver detecting a beacon signal from the wearable device, and wherein the selected localisation procedure is determined to be the second localisation procedure based on the fixed radio receiver failing to detect a beacon signal from the wearable device; and determining a location indication of the wearable device based on the selected localisation procedure.

The second localisation procedure may be based on the wearable device localising itself, in which case the determining a location indication comprises receiving the location indication from the wearable device.

The method may further comprise: obtaining a geofence for the wearable device; determining a distance indication between the wearable device and the geofence; determining a location update time based on the distance indication, the location update time indicating when a subsequent location indication is to be determined and transmitted from the wearable device based on the second localisation procedure; and transmitting the location update time to the wearable device.

The method may further comprise: determining a velocity indication of the wearable device, the velocity indication comprising a speed and direction of movement of the wearable device. In this case, the determining a location update time is based also on the velocity of the wearable device.

The determining a velocity indication may be based on multiple location indications received from the wearable device.

The determining a velocity indication may be based on accelerometer readings from the wearable device.

The method may further comprise: determining that an alarm has been triggered using the wearable device; and transmitting a location update command to the wearable device, causing the wearable device to increase a frequency of location updates based on the second localisation procedure.

The method may further comprise: determining that a health measurement from the wearable device indicates an abnormal health condition; and transmitting a location update command to the wearable device, causing the localisation procedure.

The second localisation procedure may be a localisation procedure that is suitable for outdoor localisation.

The second localisation procedure may be based on satellite-based location determination.

The beacon signal, for the first localisation procedure, may be a Bluetooth Low Energy, BLE, beacon signal.

According to a second aspect, a location determiner for locating a wearable device is provided, the location determiner being separate from the wearable device. The location determiner comprises: processing circuitry; and memory circuitry storing instructions that, when executed by the processing circuitry, cause the location determiner to: determine a selected localisation procedure to be a first localisation procedure or a second localisation procedure, wherein the selected localisation procedure is determined to be the first localisation procedure based on a fixed radio receiver detecting a beacon signal from the wearable device, and wherein the selected localisation procedure is determined to be the second localisation procedure based on the fixed radio receiver failing to detect a beacon signal from the wearable device; and determine a location indication of the wearable device based on the selected localisation procedure.

The second localisation procedure may be based on the wearable device localising itself. In this case, the instructions to determine a location indication comprise instructions that, when executed by the processing circuitry, cause the location determiner to receive the location indication from the wearable device.

The location determiner may further comprise instructions that, when executed by the processing circuitry, cause the location determiner to: obtain a geofence for the wearable device; determine a distance indication between the wearable device and the geofence; determine a location update time based on the distance indication, the location update time indicating when a subsequent location indication is to be determined and transmitted from the wearable device based on the second localisation procedure; and transmit the location update time to the wearable device.

The location determiner may further comprise instructions that, when executed by the processing circuitry, cause the location determiner to: determine a velocity of the wearable device, the velocity comprising a speed and direction of movement of the wearable device. In this case, the instructions to determine a location update time is based also on the velocity of the wearable device.

The instructions to determine a velocity may comprise instructions that, when executed by the processing circuitry, cause the location determiner to determine the velocity based on multiple location indications received from the wearable device.

The instructions to determine a velocity may comprise instructions that, when executed by the processing circuitry, cause the location determiner to determine the velocity based on accelerometer readings from the wearable device.

The location determiner may further comprise instructions that, when executed by the processing circuitry, cause the location determiner to: determine that an alarm has been triggered using the wearable device; and transmit a location update command to the wearable device, causing the wearable device to increase a frequency of location updates based on the second localisation procedure.

According to a third aspect, a computer program for locating a wearable device is provided. The computer program comprises computer program code which, when executed on a location determiner separate from the wearable device, causes the location determiner to: determine a selected localisation procedure to be a first localisation procedure or a second localisation procedure, wherein the selected localisation procedure is determined to be the first localisation procedure based on a fixed radio receiver detecting a beacon signal from the wearable device, and wherein the selected localisation procedure is determined to be the second localisation procedure based on the fixed radio receiver failing to detect a beacon signal from the wearable device; and determine a location indication of the wearable device based on the selected localisation procedure.

According to a fourth aspect, a computer program product is provided comprising a computer program according to the third aspect and a computer readable means comprising non-transitory memory in which the computer program is stored.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated.

### BRIEF DESCRIPTION OF THE DRAWINGS

Aspects and embodiments are now described, by way of example, with reference to the accompanying drawings, in which:

FIGS. 1A-B are schematic diagrams illustrating environments in which embodiments of the present invention can be applied;

FIG. 2 is a schematic drawing illustrating how the velocity of the wearable device is exploited to determine when to apply the second localisation procedure;

FIGS. 3A-C are flow charts illustrating embodiments of methods for locating a wearable device, performed by a location determiner being separate from the wearable device;

FIG. 4 is a schematic diagram illustrating components of the location determiner of FIGS. 1A-B; and

FIG. 5 shows one example of a computer program product comprising computer readable means.

### DETAILED DESCRIPTION

The aspects of the present disclosure will now be described more fully hereinafter with reference to the accompanying drawings, in which certain embodiments of the invention are shown. These aspects may, however, be embodied in many different forms and should not be construed as limiting; rather, these embodiments are provided by way of example so that this disclosure will be thorough and complete, and to fully convey the scope of all aspects of invention to those skilled in the art. Like numbers refer to like elements throughout the description.

According to embodiments presented herein, it is provided a way to locate a wearable device using one of two possible localisation procedures. A first localisation procedure is based on one or more fixed radio receivers detecting a beacon signal from the wearable device. The first localisation procedure is applicable where the fixed radio receivers can be provided, e.g., indoors or in a controlled limited physical space such as within the premises of a property where the radio receivers can be provided. On the other hand, when the fixed radio receivers do not detect any beacon signal from the wearable device, a second localisation procedure is used. The second localisation procedure is not based on the radio receivers and can thereby be applied in a wider geographic region, e.g., outdoors in general. In this way, both indoor positioning and outdoor positioning are enabled. Moreover, by basing the first localisation procedure on a beacon signal from the wearable device (rather than the wearable device receiving beacons from fixed transmitters), power consumption is greatly reduced. By using two different localisation procedures based on signal detection, the method can provide more accurate and reliable location information in multiple different environments. Furthermore, the provided solution is scalable and can be applied to a wide range of wearable devices, and can be integrated into existing systems without significant modifications.

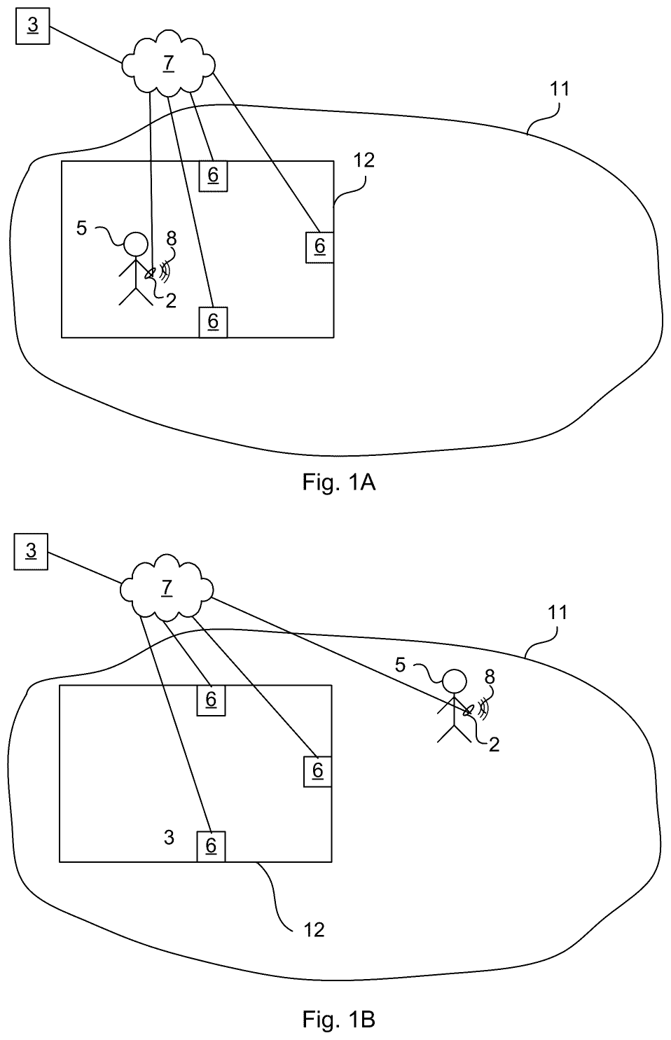

FIGS. 1A-B are schematic diagrams illustrating environments in which embodiments of the present invention can be applied. The environment can be a health monitoring system or a health automation system, for monitoring the location, and optionally health, of a user 5. The user 5 carries a wearable device 2. The wearable device 2 can be any electronic device that can behave in the way that is described herein. For instance, the wearable device 2 can be a smartwatch, a smart ring, a smart necklace, or even a smartphone. The wearable device 2 is worn or carried by the user 5. The wearable device 2 is optionally a generic device that has been configured to only execute an application provided for health/location monitoring. In such a case, the wearable device 2 has been configured to be in a state where it is prevented that any other user applications are run, such as any games, media applications, social media applications, calendars, e-mail clients, productivity tools, etc. Such a state is sometimes called a kiosk mode, or single app mode. In such a mode, the user is also prevented from adjusting settings such as deactivating BLE, enabling airplane mode, etc. Even switching the wearable device off cannot be done in the usual way. Using this state conserves power consumption in the wearable device 2. The wearable device 2 can optionally comprise a user interface element being an alarm actuator, allowing the user 5 to trigger an alarm, whereby help can be dispatched to the user 5 when needed. Such a user interface element can be a physical button and/or an area of a touchscreen. Optionally, the wearable device 2 can detect when it is being worn or not by the user 5, e.g., using a proximity sensor in the wearable device 2. An alarm can then be triggered if the wearable device 2 is not worn for an unusually long period of time, or the wearable device 2 is not worn at a time when the wearable device 2 is expected to be worn. Another example is when the wearable device 2 is not worn where it should be worn. For example, the system can be configured to trigger an alarm if the user 5 removes the wearable device 2 in a hallway. Optionally, it is acceptable to take the wearable device 2 off if the wearable device 2 is subsequently connected to a charger within a predefined period from taking the wearable device 2 off.

A location determiner 3 is used to determine a location of the wearable device 2, and thereby the user 5. The location determiner 3 can be a server or any other suitable computing device that can perform the functions described herein that are performed by the location determiner 3. The wearable device 2 and the location determiner 3 can communicate with each other, in any suitable manner. For instance, the connection between the wearable device 2 and the location determiner 3 can be based on IP (Internet Protocol) communication over a communication network 7. The communication network 7 can, for example, comprise any one or more of a local wireless network, a cellular network, a wired local-area network, a wide-area network (such as the Internet), etc. Optionally, the wearable device 2 communicates via an intermediate device, e.g., a smartphone or gateway, to be able to connect to the communication network 7.

It is to be noted that there can be other servers and components in the system that are not shown here, such as a monitoring service, an alarm service, personnel devices, etc.

The wearable device 2 can be located using a first localisation procedure or a second localisation procedure, which is a selection that is performed by the location determiner 3. Generally, the first localisation procedure is preferable when the wearable device 2 is indoors, while the second localisation procedure is preferable when the wearable device 2 is outdoors. A building 12 is shown, defining when the wearable device 2 is inside the building 12 or outside the building 12.

A geofence 11 can be applied. The wearable device 2, and the user 5, should then normally be located inside the geofence 11. Such a geofence 11 can for instance be applied when the user 5 is an elderly person who might not be able to find their way back to the building 12 if wandering off too far. The geofence 11 can thus be used when the safety of the user 5 depends on the person being contained within a certain area. When the wearable device 2 is located outside the geofence 11, an alarm can be raised, allowing personnel to find and guide the person to the safe space inside the geofence 11.

Looking now specifically to FIG. 1A, there are a number of fixed radio receivers 6 inside the building 12. The radio receivers 6 are fixedly mounted somewhere in or on the building 12. Each radio receiver 6 is directly or indirectly (e.g., via a gateway) connected to the communication network 7. In this way, each radio receiver 6 can communicate with the location determiner 3.

In the scenario illustrated in FIG. 1A, the wearable device 2 can be located using a first localisation procedure. For the first localisation procedure, the wearable device 2 transmits a beacon signal 8. When a fixed radio receiver 6 is within range of the beacon signal 8, the fixed radio receiver 6 receives the beacon signal 8. The first localisation procedure can be rudimentary, such that the wearable device 2 being within range of a particular fixed radio receiver 6 is sufficiently accurate for the first localisation procedure. Optionally, when multiple radio receivers 6 receive the beacon signal 8, the location of the wearable device 2 can be determined, e.g., using triangulation of signal strength and/or timing of the beacon signal 8 as received at the radio receivers 6. This first localisation procedure (e.g., being within range of a fixed radio receiver or using triangulation of the beacon signal 8 from the wearable device 2) is mainly applicable when the wearable device 2 is inside the building 12, as shown in FIG. 1A.

It is to be noted that the beacon signal 8 does not need to be a directional signal. In particular, the beacon signal 8 can be an omnidirectional signal, such that the beacon signal 8 is not particularly dependent on the orientation of the wearable device 2.

The determination of the location of the wearable device 2 can occur in one or more of the radio receivers 6 or in the location determiner 3. When the location determination occurs in the radio receiver(s) 6, an indication of location (as determined by one or more of the radio receivers 6) is transmitted to the location determiner 3. When the location determination occurs in the location determiner 3, the radio receivers 6 can, for instance, transmit their raw measurements of the beacon signal 8, or a processed signal that is based on the raw measurements of the beacon signal 8, to the location determiner 3, to enable the location determiner 3 to determine the location.

Looking now to FIG. 1B, the wearable device 2 (and the user 5) are outside the building 12. In this situation, the radio receivers 6 are unable to receive the beacon signal 8 from the wearable device 2. Instead, the second localisation procedure is used to locate the wearable device 2.

The second localisation procedure is based on the wearable device 2 localising itself, e.g., when the wearable device 2 is outside the building 12 and the radio receivers 6 cannot detect the beacon signal 8 from the wearable device 2. For instance, the second localisation procedure can be a satellite-based localisation procedure, such as GPS (Global Positioning Service), Galileo, Glonass, etc.

In order to balance how often the second localisation procedure is performed to save energy, the location determiner 3 communicates with the wearable device 2, to influence or command when a localisation according to the second localisation procedure is to be obtained by the wearable device 2. As explained in more detail below, one or more factors can influence the timing of when the second localisation procedure is to be applied. The second localisation procedure can be avoided when not needed, since each time the second localisation procedure is performed, energy is consumed in the wearable device 2.

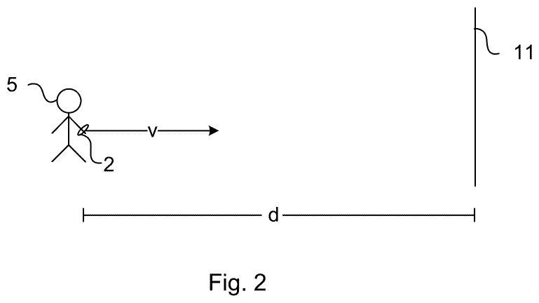

FIG. 2 is a schematic drawing illustrating how the velocity of the wearable device 2 is exploited to determine when to apply the second localisation procedure.

The velocity v of the wearable device 2 is determined by the location determiner 3. The velocity comprises both the speed (without indication of direction) as well as an indication of direction of movement. For the sake of clarity of explanation, the direction in FIG. 2 of the velocity is towards the geofence 11. A distance d is also shown in FIG. 2, indicating the distance between the wearable device 2 and the geofence 11.

Based on the velocity v and the distance d, the location determiner 3 can determine how soon the wearable device 2 is expected to reach the geofence 11. For instance, if the wearable device 2 is expected to reach the geofence 11 in ten seconds, the location determiner 3 might determine to apply the second localisation procedure before the end of those ten seconds. On the other hand, if the wearable device 2 is expected to reach the geofence 11 in ten minutes, the second localisation procedure might not be applied for another several minutes. In this way, the frequency of applying the second localisation procedure is adapted based on when the wearable device 2 is expected to reach the geofence 11. Since the second procedure consumes power at the wearable device 2, this achieves a balance between power consumption at the wearable device 2 and the need for localisation, which increases when the user 5 is close to the geofence 11, and especially if the user 5 is also moving towards the geofence 11 at the risk of crossing it.

While FIG. 2 only shows one dimension, the same principle can be applied in a two-dimensional, or even three-dimensional, location determination, as long as it can be determined how soon the wearable device 2 is expected to reach the geofence 11, e.g., by determining the velocity in a direction being a normal to the geofence 11 towards the wearable device 2.

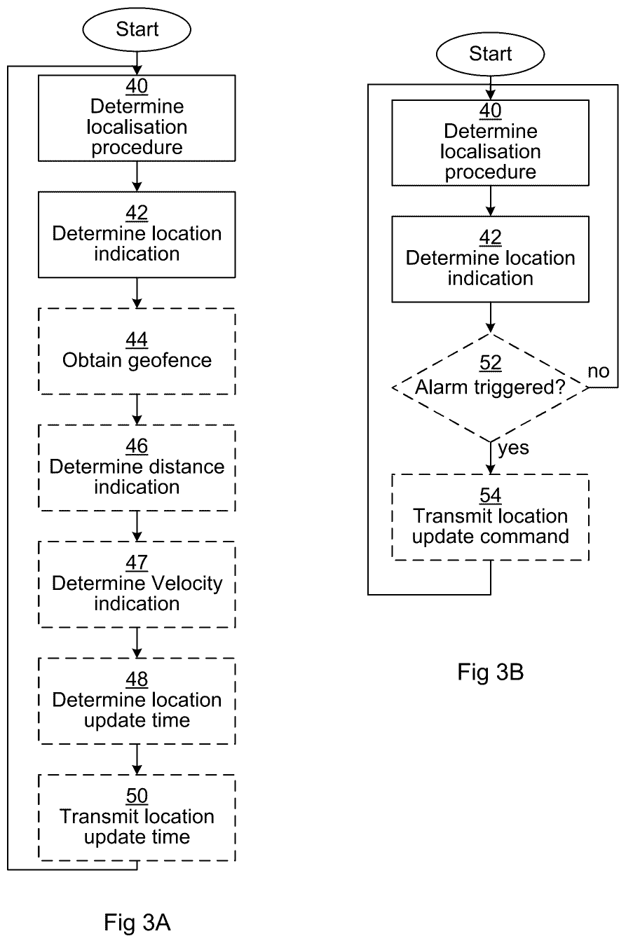

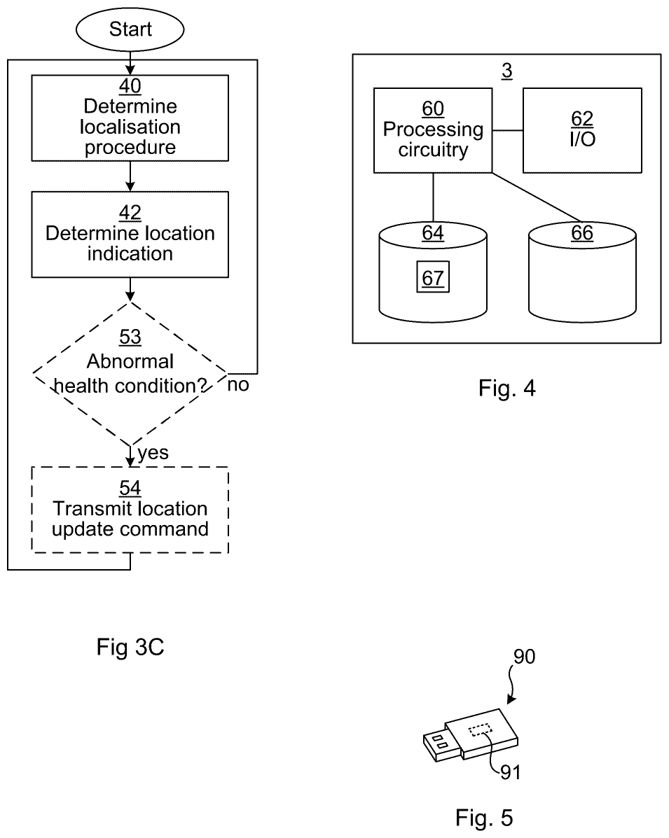

FIGS. 3A-C are flow charts illustrating embodiments of methods for locating a wearable device 2. These embodiments are performed by the location determiner 3. It is noted that the location determiner 3 is separate from the wearable device 2.

In a determine localisation procedure step 40, the location determiner 3 determines a selected localisation procedure to be a first localisation procedure or a second localisation procedure. The selected localisation procedure is determined to be the first localisation procedure based on a fixed radio receiver 6 detecting a beacon signal 8 from the wearable device 2. In contrast, the selected localisation procedure is determined to be the second localisation procedure based on a fixed radio receiver 6 failing to detect a beacon signal 8 from the wearable device 2. In other words, when the radio receivers 6 can detect the beacon signal 8, the first localisation procedure is used, and when the radio receivers 6 are unable to detect the beacon signal 8, the second localisation procedure is used. The beacon signal 8, for the first localisation procedure, can be, for example, a Bluetooth Low Energy (BLE) beacon signal 8 which is an energy-efficient beacon signal 8, preserving power in the wearable device 2.

In one embodiment, it is sufficient that a single fixed radio receiver 6 detects the beacon signal 8 for the first localisation procedure to be used. The wearable device 2 is then considered to be located at a position within a circle, defined by an estimated range of the beacon signal 8, of the fixed radio receiver 6 that detects the beacon signal 8.

Optionally, at least three fixed radio receivers 6 need to detect the beacon signal 8 for the first localisation procedure to be used, allowing location determination based on triangulation of the wearable device 2 in two dimensions.

As explained above with reference to FIG. 1B, the second localisation procedure can be based on the wearable device 2 localising itself. In particular, the second localisation procedure can be a localisation procedure that is suitable for outdoor localisation, such as based on satellite-based location determination (e.g., GPS, Galileo, Glonass, etc.).

In a determine location indication step 42, the location determiner 3 determines a location indication of the wearable device 2 based on the selected localisation procedure. For instance, when the selected localisation procedure is the first localisation procedure, the wearable device 2 is located based on the beacon signal 8 transmitted by the wearable device 2. The location indication can be in the form of a coordinate pair (absolute longitude and absolute latitude in a global geographic coordinate system). Alternatively, the location indication can be in the form of cartesian or polar coordinates relative to a fixed point, such as a particular point (e.g., center of the front door) of the building 12.

When the second localisation procedure is based on the wearable device 2 localising itself, the determining a location indication comprises receiving the location indication from the wearable device 2 (e.g., over the communication network 7).

In an optional obtain geofence step 44, the location determiner 3 obtains a geofence 11 for the wearable device 2. The geofence 11 can be associated with the wearable device 2 (and thus the user 5) and can be retrieved from a database, where the database can be local or remote to the location determiner 3. The geofence 11 can be defined as a list of coordinates (in the same coordinate system or transformable coordinate system to the coordinate system used for the location indication). The list of coordinates defines a polygon that makes up the geofence 11 (optionally with some smoothing applied to round off the edge points of the polygon).

In an optional determine distance indication step 46, the location determiner 3 determines a distance indication between the wearable device 2 and the geofence 11. The distance indication can be determined as the shortest distance from the wearable device 2 to the geofence 11.

In an optional determine velocity indication step 47, the location determiner 3 determines a velocity indication of the wearable device 2. The velocity indication comprises a speed (e.g., as a scalar quantity) and direction of movement of the wearable device 2. In other words, the velocity indication is a vector.

The velocity can be determined based on multiple location indications received from the wearable device 2. A difference in position between the location indications can then be used (along with the difference in times of obtaining the two location indications) to determine an average velocity between the two instances of the location indications.

Alternatively or additionally, the velocity can be determined based on accelerometer readings from the wearable device 2, where the velocity can be derived by integrating the accelerometer readings.

In an optional determine location update time step 48, the location determiner 3 determines a location update time based on the distance indication. The location update time indicates when a subsequent location indication is to be determined and transmitted from the wearable device 2 based on the second localisation procedure.

Optionally, the location update time is indirectly indicated to the wearable device 2, for instance, the location update can indicate that the wearable device 2 should provide its location indication to the location determiner 3 when the wearable device 2 has moved an identified amount of distance, e.g., x meters, from its current position.

For instance, if the wearable device 2 is very close to the geofence 11 (i.e., the distance is small), the location update time can be determined to be very soon, while if the wearable device 2 is nowhere near the geofence 11 (i.e., the distance is large), the location update time can be determined to be a long time from now.

When the velocity is available, the location update time can be determined also based on the velocity of the wearable device 2, e.g., as explained above with reference to FIG. 2.

In an optional transmit location update time step 50, the location determiner 3 transmits the location update time to the wearable device 2. The wearable device 2 will determine and transmit its location based on the second localisation procedure in accordance with the location update time. In this way, the location determiner 3 controls when the wearable device 2 performs its location determination based on the second localisation procedure, to achieve a balance between power consumption and relevant location updates of the wearable device 2.

Looking now to FIG. 3B, only new or modified steps compared to those described with reference to FIG. 3A are described.

In an optional conditional alarm triggered step 52, the location determiner 3 determines whether an alarm has been triggered (e.g., by the user) using the wearable device 2. When the location determiner 3 determines that an alarm has been triggered, the method proceeds to a transmit location update step 54. Otherwise, the method returns to the determine localisation procedure step 40.

In the optional transmit location update command step 54, the location determiner 3 transmits a location update command to the wearable device 2. The location update command causes the wearable device 2 to increase a frequency of location updates. This is applied for location updates based on the second localisation procedure.

In one embodiment the wearable device 2 is configured such that when the alarm has been triggered and there is an incoming call (voice call and/or video call), the wearable device 2 automatically answers the incoming call, optionally with a high (such as maximum) volume setting.

When the alarm has been triggered by the user, current and accurate localisation updates are more important than power consumption (as long as there is enough power in the wearable device 2 for it to be operable until the user 5 and the wearable device 2 are found). In this way, the location determiner 3 can provide the current location of the wearable device 2 to personnel that are dispatched to find and help the user 5.

Looking now to FIG. 3C, only new or modified steps compared to those described with reference to FIG. 3A are described.

In an optional conditional abnormal health condition step 53, the location determiner 3 determines whether a health measurement from the wearable device 2 indicates an abnormal health condition. The abnormal health condition can, for instance, be determined based on the pulse of the user 5 exceeding a certain threshold or the pulse of the user 5 falling below another threshold. Alternatively or additionally, the abnormal health condition can be determined based on a body temperature of the user 5. The measurements for the health condition can be retrieved directly from the wearable device 2 or from a health data-related server with which the wearable device 2 communicates. When the location determiner 3 determines that an abnormal health condition is indicated, the method proceeds to the transmit location update step 54. Otherwise, the method returns to the determine localisation procedure step 40.

In the transmit location update command step 54, the location determiner 3 transmits a location update command to the wearable device 2, causing the wearable device 2 to increase a frequency of location updates based on the second localisation procedure. This step corresponds to the transmit location update command step 54 of FIG. 3B.

It is to be noted that the embodiments of FIGS. 3A-C can be freely combined in a composite system as suitable.

Similar to the situation explained with reference to FIG. 3B, when abnormal health condition is determined, current and accurate localisation updates are more important than power consumption (as long as there is enough power in the wearable device 2 for it to be operable until the user 5 and the wearable device 2 are found). In this way, the location determiner 3 can provide the current location of the wearable device 2 to personnel that are dispatched to find and help the user 5 in a potential health emergency.

FIG. 4 is a schematic diagram illustrating components of the location determiner 3 of FIGS. 1A-B. Processing circuitry 60 is provided using any combination of one or more of a suitable central processing unit (CPU), graphics processing unit (GPU), multiprocessor, neural processing unit (NPU), microcontroller, digital signal processor (DSP), etc., capable of executing software instructions 67 stored in memory circuitry 64, which can thus be a computer program product. The processing circuitry 60 could alternatively be implemented using an application specific integrated circuit (ASIC), field programmable gate array (FPGA), etc. The processing circuitry 60 can be configured to execute the method described with reference to FIGS. 3A-C above.

The memory circuitry 64 can be any combination of random-access memory (RAM) and/or read-only memory (ROM). The memory circuitry 64 also comprises non-transitory persistent storage, which, for example, can be any single one or combination of magnetic memory, optical memory, solid-state memory or even remotely mounted memory.

A data memory 66 is also provided for reading and/or storing data during execution of software instructions in the processing circuitry 60. The data memory 66 can be any combination of RAM and/or ROM.

The location determiner 3 further comprises an I/O interface 62 for communicating with external and/or internal entities. Optionally, the I/O interface 62 also includes a user interface.

An I/O interface 62 is provided for communicating with external and/or internal entities over the communication network 7. This communication can be based on wired communication, e.g., based on Ethernet, and/or wireless communication, e.g., Wi-Fi, Bluetooth, Bluetooth Low Energy, and/or a cellular network, complying with any one or a combination of sixth generation (6G) mobile networks, next generation mobile networks (fifth generation, 5G), LTE (Long Term Evolution), UMTS (Universal Mobile Telecommunications System) utilising W-CDMA (Wideband Code Division Multiplex), or any other current or future wireless network, as long as the principles described hereinafter are applicable.

Other components of the location determiner 3 are omitted in order not to obscure the concepts presented herein.

FIG. 5 shows one example of a computer program product 90 comprising computer readable means. On this computer readable means, a computer program 91 can be stored in a non-transitory memory. The computer program can cause processing circuitry to execute a method according to embodiments described herein. In this example, the computer program product 90 is in the form of a removable solid-state memory, e.g., a Universal Serial Bus (USB) drive. As explained above, the computer program product could also be embodied in a memory of a device, such as the computer program product 64 of FIG. 4. While the computer program 91 is here schematically shown as a section of the removable solid-state memory, the computer program can be stored in any way which is suitable for the computer program product, such as another type of removable solid-state memory, or an optical disc, such as a CD (compact disc), a DVD (digital versatile disc) or a Blu-Ray disc.

Here now follows a list of enumerated embodiments from another perspective.

Embodiment 1. A method for locating a wearable device, the method being performed by a location determiner being separate from the wearable device, the method comprising:
determining a selected localisation procedure to be a first localisation procedure or a second localisation procedure, wherein the selected localisation procedure is determined to be the first localisation procedure based on a fixed radio receiver detecting a beacon signal from the wearable device, and wherein the selected localisation procedure is determined to be the second localisation procedure based on the fixed radio receiver failing to detect a beacon signal from the wearable device; and
determining a location indication of the wearable device based on the selected localisation procedure.

Embodiment 2. The method according to embodiment 1, wherein the second localisation procedure is based on the wearable device localising itself, and wherein the determining a location indication comprises receiving the location indication from the wearable device.

Embodiment 3. The method according to embodiment 2, further comprising:
obtaining a geofence for the wearable device;
determining a distance indication between the wearable device and the geofence;
determining a location update time based on the distance indication, the location update time indicating when a subsequent location indication is to be determined and transmitted from the wearable device based on the second localisation procedure; and
transmitting the location update time to the wearable device.

Embodiment 4. The method according to embodiment 3, further comprising:
determining a velocity indication of the wearable device, the velocity indication comprising a speed and direction of movement of the wearable device;
and wherein the determining a location update time is based also on the velocity of the wearable device.

Embodiment 5. The method according to embodiment 4, wherein the determining a velocity indication is based on multiple location indications received from the wearable device.

Embodiment 6. The method according to embodiment 4 or 5, wherein the determining a velocity indication is based on accelerometer readings from the wearable device.

Embodiment 7. The method according to any one of embodiments 2 to 6, further comprising:
determining that an alarm has been triggered using the wearable device; and
transmitting a location update command to the wearable device, causing the wearable device to increase a frequency of location updates based on the second localisation procedure.

Embodiment 8. The method according to any one of embodiments 2 to 5, further comprising:
determining that a health measurement from the wearable device indicates an abnormal health condition; and
transmitting a location update command to the wearable device, causing the localisation procedure.

Embodiment 9. The method according to any one of the preceding embodiments, wherein the second localisation procedure is a localisation procedure that is suitable for outdoor localisation.

Embodiment 10. The method according to embodiment 9, wherein the second localisation procedure is based on satellite-based location determination.

Embodiment 11. The method according to any one of the preceding embodiments, wherein the beacon signal, for the first localisation procedure, is a Bluetooth Low Energy, BLE, beacon signal.

Embodiment 12. A location determiner for locating a wearable device, the location determiner being separate from the wearable device, the location determiner comprising:
processing circuitry; and
memory circuitry storing instructions that, when executed by the processing circuitry, cause the location determiner to:
determine a selected localisation procedure to be a first localisation procedure or a second localisation procedure, wherein the selected localisation procedure is determined to be the first localisation procedure based on a fixed radio receiver detecting a beacon signal from the wearable device, and wherein the selected localisation procedure is determined to be the second localisation procedure based on the fixed radio receiver failing to detect a beacon signal from the wearable device; and
determine a location indication of the wearable device based on the selected localisation procedure.

Embodiment 13. The location determiner according to embodiment 12, wherein the second localisation procedure is based on the wearable device localising itself, and wherein the instructions to determine a location indication comprise instructions that, when executed by the processing circuitry, cause the location determiner to receive the location indication from the wearable device.

Embodiment 14. The location determiner according to embodiment 13, further comprising instructions that, when executed by the processing circuitry, cause the location determiner to:
obtain a geofence for the wearable device;
determine a distance indication between the wearable device and the geofence;
determine a location update time based on the distance indication, the location update time indicating when a subsequent location indication is to be determined and transmitted from the wearable device based on the second localisation procedure; and
transmit the location update time to the wearable device.

Embodiment 15. The location determiner according to embodiment 14, further comprising instructions that, when executed by the processing circuitry, cause the location determiner to:
determine a velocity of the wearable device, the velocity comprising a speed and direction of movement of the wearable device;
and wherein the instructions to determine a location update time is based also on the velocity of the wearable device.

Embodiment 16. The location determiner according to embodiment 15, wherein the instructions to determine a velocity comprise instructions that, when executed by the processing circuitry, cause the location determiner to determine the velocity based on multiple location indications received from the wearable device.

Embodiment 17. The location determiner according to embodiment 15 or 16, wherein the instructions to determine a velocity comprise instructions that, when executed by the processing circuitry, cause the location determiner to determine the velocity based on accelerometer readings from the wearable device.

Embodiment 18. The location determiner according to any one of embodiments 13 to 17, further comprising instructions that, when executed by the processing circuitry, cause the location determiner to:
determine that an alarm has been triggered using the wearable device; and
transmit a location update command to the wearable device, causing the localisation procedure.

Embodiment 19. A computer program for locating a wearable device, the computer program comprising computer program code which, when executed on a location determiner separate from the wearable device, causes the location determiner to:
determine a selected localisation procedure to be a first localisation procedure or a second localisation procedure, wherein the selected localisation procedure is determined to be the first localisation procedure based on a fixed radio receiver detecting a beacon signal from the wearable device, and wherein the selected localisation procedure is determined to be the second localisation procedure based on the fixed radio receiver failing to detect a beacon signal from the wearable device; and
determine a location indication of the wearable device based on the selected localisation procedure.

Embodiment 20. A computer program product comprising a computer program according to embodiment 19 and a computer readable means comprising non-transitory memory in which the computer program is stored.

The aspects of the present disclosure have mainly been described above with reference to a few embodiments. However, as is readily appreciated by a person skilled in the art, other embodiments than the ones disclosed above are equally possible within the scope of the invention, as defined by the appended patent claims. Thus, while various aspects and embodiments have been disclosed herein, other aspects and embodiments will be apparent to those skilled in the art. The various aspects and embodiments disclosed herein are for purposes of illustration and are not intended to be limiting, with the true scope being indicated by the following claims.

1. A method for locating a wearable device, the method being performed by a location determiner being separate from the wearable device, the method comprising:
determining a selected localisation procedure to be a first localisation procedure or a second localisation procedure, wherein the selected localisation procedure is determined to be the first localisation procedure based on a fixed radio receiver detecting a beacon signal from the wearable device, and wherein the selected localisation procedure is determined to be the second localisation procedure based on the fixed radio receiver failing to detect a beacon signal from the wearable device; and
determining a location indication of the wearable device based on the selected localisation procedure.

2. The method according to claim 1, wherein the second localisation procedure is based on the wearable device localising itself, and wherein the determining the location indication comprises receiving the location indication from the wearable device.

3. The method according to claim 2, further comprising:
obtaining a geofence for the wearable device;
determining a distance indication between the wearable device and the geofence;
determining a location update time based on the distance indication, the location update time indicating when a subsequent location indication is to be determined and transmitted from the wearable device based on the second localisation procedure; and
transmitting the location update time to the wearable device.

4. The method according to claim 3, further comprising:
determining a velocity indication of the wearable device, the velocity indication comprising a speed and direction of movement of the wearable device;
and wherein the determining the location update time is based also on the velocity of the wearable device.

5. The method according to claim 4, wherein the determining the velocity indication is based on multiple location indications received from the wearable device.

6. The method according to claim 4, wherein the determining the velocity indication is based on accelerometer readings from the wearable device.

7. The method according to claim 2, further comprising:
determining that an alarm has been triggered using the wearable device; and
transmitting a location update command to the wearable device, causing the wearable device to increase a frequency of location updates based on the second localisation procedure.

8. The method according to claim 2, further comprising:
determining that a health measurement from the wearable device indicates an abnormal health condition; and
transmitting a location update command to the wearable device, causing the wearable device to increase a frequency of location updates based on the second localisation procedure.

9. The method according to claim 1, wherein the second localisation procedure is a localisation procedure that is suitable for outdoor localisation.

10. The method according to claim 9, wherein the second localisation procedure is based on satellite-based location determination.

11. The method according to claim 1, wherein the beacon signal, for the first localisation procedure, is a Bluetooth Low Energy, BLE, beacon signal.

12. A location determiner for locating a wearable device, the location determiner being separate from the wearable device, the location determiner comprising:
processing circuitry; and
memory circuitry storing instructions that, when executed by the processing circuitry, cause the location determiner to:
determine a selected localisation procedure to be a first localisation procedure or a second localisation procedure, wherein the selected localisation procedure is determined to be the first localisation procedure based on a fixed radio receiver detecting a beacon signal from the wearable device, and wherein the selected localisation procedure is determined to be the second localisation procedure based on the fixed radio receiver failing to detect a beacon signal from the wearable device; and
determine a location indication of the wearable device based on the selected localisation procedure.

13. The location determiner according to claim 12, wherein the second localisation procedure is based on the wearable device localising itself, and wherein the instructions to determine the location indication comprise instructions that, when executed by the processing circuitry, cause the location determiner to receive the location indication from the wearable device.

14. The location determiner according to claim 13, further comprising instructions that, when executed by the processing circuitry, cause the location determiner to:
obtain a geofence for the wearable device;
determine a distance indication between the wearable device and the geofence;
determine a location update time based on the distance indication, the location update time indicating when a subsequent location indication is to be determined and transmitted from the wearable device based on the second localisation procedure; and
transmit the location update time to the wearable device.

15. The location determiner according to claim 14, further comprising instructions that, when executed by the processing circuitry, cause the location determiner to:
determine a velocity of the wearable device, the velocity comprising a speed and direction of movement of the wearable device;
and wherein the instructions to determine a location update time is based also on the velocity of the wearable device.

16. The location determiner according to claim 15, wherein the instructions to determine the velocity comprise instructions that, when executed by the processing circuitry, cause the location determiner to determine the velocity based on multiple location indications received from the wearable device.

17. The location determiner according to claim 15, wherein the instructions to determine the velocity comprise instructions that, when executed by the processing circuitry, cause the location determiner to determine the velocity based on accelerometer readings from the wearable device.

18. The location determiner according to claim 13, further comprising instructions that, when executed by the processing circuitry, cause the location determiner to:
determine that an alarm has been triggered using the wearable device; and
transmit a location update command to the wearable device, causing the wearable device to increase a frequency of location updates based on the second localisation procedure.

19. A non-transitory computer readable medium storing a computer program for locating a wearable device, the computer program comprising computer program code which, when executed on a location determiner separate from the wearable device, causes the location determiner to:
determine a selected localisation procedure to be a first localisation procedure or a second localisation procedure, wherein the selected localisation procedure is determined to be the first localisation procedure based on a fixed radio receiver detecting a beacon signal from the wearable device, and wherein the selected localisation procedure is determined to be the second localisation procedure based on the fixed radio receiver failing to detect a beacon signal from the wearable device; and
determine a location indication of the wearable device based on the selected localisation procedure.
